(19) United States
(12) Patent Application Publication
(10) Pub. No.: US 2016/0231509 A1
(43) Pub. Date: Aug. 11, 2016

(54) OPTICAL FIBER ASSEMBLY AND METHOD FOR MAKING SAME

(71) Applicant: U.S. Army Research Laboratory ATTN: RDRL-LOC-I, Adelphi, MD (US)

(72) Inventor: Leonid A. Beresnev, Columbia, MD (US)

(21) Appl. No.: 14/614,694

(22) Filed: Feb. 5, 2015

(51) Int. Cl. G02B 6/36; G02B 6/38

(52) U.S. Cl. CPC G02B 6/3616; G02B 6/3894

(57) ABSTRACT

A method for mounting an optical fiber within a tube in which the optical fiber is positioned through the tube so that a portion of the fiber protrudes outwardly from the distal end of the tube. A curable material, such as an adhesive, is then applied to the optical fiber portion which, upon curing, forms a flexible solid material having the refractive index less than refractive index of cladding material of said fiber optic. The outwardly protruding portion of the fiber is then retracted back into the tube so that the flexible solid material isolates the fiber portion from the tube. In addition, different clamping assemblies are provided for attaching protective sheathing for the optic fiber to a mount for the optic fiber which permit easy disassembly and removal.

### GOVERNMENT INTEREST

The invention described herein may be manufactured, used, and licensed by or for the United States Government.

### BACKGROUND OF THE INVENTION

I. Field of the Invention

The present invention relates generally to optical assemblies for delivery of laser radiation.

II. Description of Related Art

In military applications, the irradiance or power density of a laser beam established on the target is the most essential factor for destroying the target. Generally, the better the beam quality and power of the laser beam, the higher the irradiance. For example, a laser beam having a power of 10 kilowatts can create the destructive action on a target in seconds, if focused into spot with diameter of 2-3 cm.

In recent years, the performance of lasers in military applications has improved dramatically owing to success in fiber lasers. Single mode fiber lasers have almost ideal quality of radiated beam. The wall-plug efficiency has reached the unparalleled level 40%. However, the current limiting factor for military laser applications is the limitation of the maximum power for one fiber laser. Currently, fiber lasers with high quality of emitting beam are limited to about 1 kilowatt in power. This power limitation, furthermore, is related mostly to the nonlinear effects of the laser beam.

In order to focus the laser beam on the target, a complex and expensive beam forming apparatus, such as a large mirror of high quality, has been previously required. The mitigation of beam degradation induced with atmospheric turbulences also requires expensive adaptive optics in order to achieve the necessary concentration of radiation on the target. There are also limitations related to the optical strength of the fiber optic interface which actually emits the laser beam due to its small core diameter, i.e. typically about 20 microns. This, however, may be mitigated by pining a coreless endcap to the emitting end of the fiber tip. The endcap allows one to reduce the optical strength on emitting interface (endcap facet) hundreds and thousands times to the non-dangerous power density level on facet. However the conventional endcaps have large weight and size. See for instance the U.S. patents
U.S. Pat. No. 8,213,753 from Jul. 3, 2012, by Li et al. “System for delivering the output from an optical fibre”;
U.S. Pat. No. 8,355,608 from Jan. 15, 2013, by Hu “Method and apparatus for in-line fiber-cladding-light dissipation”;
U.S. Pat. No. 8,419,293 from Apr. 16, 2013, by Zerfas et at “Methods and apparatus related to a launch connector portion of a ureteroscope laser-energy-delivery device”;
U.S. Pat. No. 8,419,296 from Apr. 16, 2013, by Murayama et al. “Optical fiber structure, system for fabricating the same, and block-like chip for use therein”;
U.S. Pat. No. 8,457,461 from Jun. 04, 2013 by Ott “Fiber optic cable assembly and method of making the same”;
U.S. Pat. No. 8,511,401 from Aug. 20, 2013, by Zediker et al. “Method and apparatus for delivering high power laser energy over long distances”;
U.S. Pat. No. 8,724,945 from May 13, 2014, by Gapontsev et al, “High power fiber laser system with integrated termination block”.
   Moreover, in many applications the endcap requires the external cooling to dissipate the parasitic radiation which appears due to reflection and scattering in endcap and nearest environment, for instance in material processing or surgery.

The previously known optical fibers typically include an optical wave-guiding core which conveys the radiation from the laser. This core is encased in a cladding having smaller refractive index RI(clad) than refractive index of core RI(core). Cladding, in turn, is encased within a polymer coating typically having the refractive index RI(coat) smaller than cladding, RI(coat)<RI(clad). However, the distal or free end of the optical fiber is subjected to high heat during the process of attaching (splicing) the endcap. This high heat may melt a portion of the polymer coating at the distal end of the optical fiber assembly. Therefore, the portion of polymer coating is typically stripped from fiber cladding before splicing the endcap.

The free or distal end of the optical fiber assembly delivering the relatively small power, not exceeding 1 W, can be typically mounted within a metal tubing which is normally optically isolated from the laser radiation which may propagate in cladding by the polymer coating owing to total internal reflection of cladding optical modes from boundary between cladding and polymer. However, when the polymer coating is removed at the distal end of the optical fiber assembly, e.g. by stripping some portion when attaching the endcap by thermal fusion, contact between the stripped portion of optical fiber and the metal tubing can occur. When this happens, light leakage can occur which results in heating of the metal tubing. This, in turn, reduces the overall efficiency of the optical fiber assembly and limits the power of the delivered radiation.

Attempts have been made to recoat the portion of the coating removed during attachment of the endcap. However, such recoating of the distal end of the optical fiber assembly is a delicate process which can damage or contaminate the facet for the endcap. Any damage to the facet for the endcap necessarily reduces the overall efficiency of the light transmission by the optical fiber assembly sometimes causing the activation of burning the fiber core up to catastrophic damage of fiber laser or fiber amplifier.

In most military applications, a plurality of optical fiber assemblies are arranged together into arrays in order to achieve the necessary total power to destroy the target. Consequently, a mount is typically provided adjacent the distal end of each of the optical fibers. Each optical fiber with its surrounding metal tube extends through a passageway in the mount and the proximal end of tube is secured to the mount in an conventional fashion. Typically the laser beams emitted by facets of distal ends of fibers may independently deviate (wander) due to vibrations and atmospheric turbulence before these beams will reach the target. This wandering may misalign the overlapping of laser beams on the same spot of target, drastically reducing the radiance on target. To provide the permanent overlapping of laser beams on the target the distal end of tube can be moved in focal planes of collimating (focusing) lenses. Typical frequencies of movements of distal end should be of the order of thousand Hertz or higher to mitigate typically very fast beam wandering. Therefore, the movable part of tube together with distal end of fiber with endcap should have very small inertia, with weight typically in range of tens of milligrams. Such strict requirement to weight and size of movable parts of fiber assembly is in very strong contradiction to heavy and bulky endcaps commonly used for radiation with power of kW level.

The portion of the optical fiber extending from the mount and to the source of radiation, however, should be also very light. Additionally, this portion is very fragile and vulnerable to abrasion and mechanical stresses. Consequently, this portion of the optical fiber extending between the source of radiation or laser and the mount is encased in one or more protective sheaths. Typically the protective sheaths like metal semi-flexible conduits are thick and heavy. In case of plurality of fiber laser array the forces of gravity and stiffness of such sheaths may misalign the position of emitting fiber tips with additional misalignment of beams on a target. Some portion of optical fiber between laser source and mount may contain much lighter and flexible tubes/pipes/sheaths made from plastic. Previously, the distal ends of such plastic sheaths have been attached to the mounts by epoxy adhesive. One disadvantage, however, of using epoxy adhesive to secure the protective sheaths to the mounts is that, in the event that the optical fiber assembly must be replaced for maintenance or other reasons, it is difficult and time consuming to detach the adhesively secured protective sheaths from the mounts.

Since the optical fibers are so thin, the optical fibers can be easily stressed and deflected for many reasons, including gravity. Such stress on the fiber can adversely affect the overall efficiency and performance of the optical fiber assembly, for instance due to appearance of high-order modes in a single-mode fibers.

Consequently, it would be advantageous to protect the optical fiber at spaced distances between its mount and the laser radiation source by such protecting means as tubes, sheaths and conduits having very small weight to avoid the stresses induced by gravity and stiffness. However, there are no previously known ways to support the weight of the optical fibers in the previously known optical fiber assemblies.

### SUMMARY OF THE PRESENT INVENTION

The present invention provides a method for making and optical fiber constructions which overcome the above-mentioned disadvantages of the previously known optical fiber assemblies.

In order to prevent contact between stripped portion of the optical fiber and its encasing metal tube adjacent the distal end of the fiber and to block the radiation leakage from cladding to inner space of said tube, the optical fiber is first extended out through the distal end of its supporting tube until all, or almost all, of the portion of the optical fiber stripped of the coating protrudes forwardly of its support tube. One or more drops of a curable material, such as an adhesive, is placed on the stripped portion of the optical fiber at longitudinally spaced positions. The curable material is then allowed to cure and form a solid but resilient and compressible material. The refractive index (RI) of said curable material (RI_{glue}) is substantially less than RI of cladding (RI_{clad}). Owing to the total internal reflection (TIR) the occasional radiation which may propagate in cladding (cladding optical modes) will be blocked from leaving the cladding.

After the adhesive has cured, the optical fiber is then retracted within its supporting tube. In doing so, the cured drops of the adhesive or other curable material are sandwiched in between the optical fiber and its support tube thus isolating the optical fiber from its support tube in the desired fashion. After the optical fiber has been retracted to its operational position, the adhesive or other sealant with refractive index RI_{glue} smaller than RI_{clad} is then applied to the distal end of the optical fiber support tube thus sealing the distal end of the support tube and the optical fiber together and preventing contact between the support tube and the optical fiber including the prevention of parasitic radiation leakage from fiber cladding into inner space of support tube.

The support tube for the optical fiber is secured to a mount associated with the optical fiber in any conventional fashion, such as by an adhesive. However, in order to protect the portion of the optical fiber extending from the mount and to the radiation source, at least one, and preferably two or more sheaths are provided around the optical fiber.

Unlike the previously known sheaths, however, in the present invention the distal end of the innermost sheath is positioned around the support tube for the optic fiber and is positioned within an outwardly flared cavity formed on the optical fiber mount. A radially inwardly compressible shimming lock is inserted into the mold cavity. Upon doing so, the coaction between the mold and the shimming lock causes the shimming lock to compress radially inwardly thus sandwiching the distal end of the inner protective sheath in between the shimming lock and the support tube for the optical fiber. However, when desired, the shimming lock may be easily and rapidly removed.

In order to attach an outer sheathing around the optic fiber between the mount and the laser radiation source, a distal end of the outer sheath is pressed over an outwardly flared portion of the mount which causes the distal end of the outer sheath to flare outwardly. A compression ring is then pressed over the outwardly flared portion of the outer sheath thus sandwiching the distal end of the outer sheath in between the compression ring and the mount thus securing them together. The appropriate cone-like shape of inner cavity, of outwardly flared portion of mount and inner surface of compression ring are promoting the easy and reliable attachment of inner and other light plastic sheaths to the mount.

An adapter for supporting the optical cable assembly at spaced locations is also provided. The adapter is generally cylindrical in shape having one end adapted for attachment to a structure, such as the mount for the optical fiber assembly. An outer protecting plastic sheath/tube is positioned within the other end of the adapter and surrounded by a pair of conical inserts which are radially movable relative to each other. Each insert includes a conical surface.

A nut is threadably mounted to the end of the adapter. This nut includes an inner conical surface which co-acts with the conical surface of the insert as the nut is tightened. Consequently, as the nut is tightened, the nut forces the inserts radially inwardly and towards the support tube. A resilient gasket is preferably provided between the inserts and the outer protecting sheath so that, upon tightening of the nut, the said outer sheath is firmly attached to the adapter.

### BRIEF DESCRIPTION OF THE DRAWING

A better understanding of the present invention will be had upon reference to the following detailed description when read in conjunction with the accompanying drawing, wherein like reference characters refer to like parts throughout the several views, and in which:

FIG. 1 is a fragmentary side longitudinal sectional view illustrating a preferred embodiment of the invention;

FIG. 2 is a view similar to FIG. 1, but illustrating the fiber optic retracted into its support tube;

FIG. 3 is a longitudinal sectional view illustrating the attachment system for the protective sheaths for the fiber optic assembly;

FIG. 4 is a view illustrating the shimming lock used to attach the protective sheaths;

FIG. 5 is a longitudinal sectional view of an adapter and associated fiber optic assembly;

FIG. 6 is a view similar to FIG. 5, but illustrating the adapter in its locked position; and

FIG. 7 is an elevational view of the locking insert used in connection with the adapter.

### DETAILED DESCRIPTION OF PREFERRED EMBODIMENTS OF THE PRESENT INVENTION

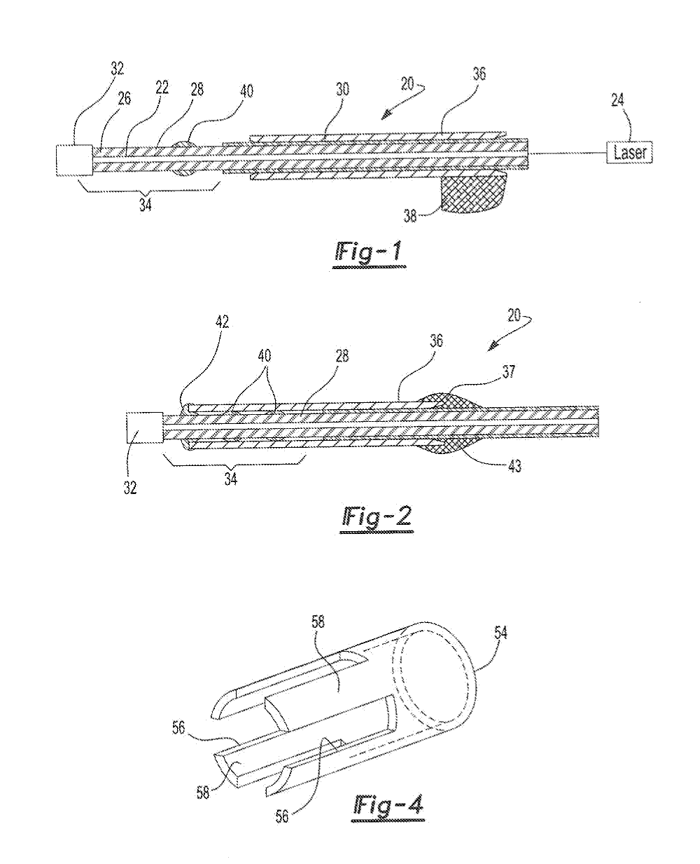

With reference first to FIG. 1, a portion of an optical fiber assembly 20 in accordance with the present invention is shown. The assembly 20 includes an optic fiber core 22 with typical diameter 10-30 μm which conveys the radiation from a laser 24 to a distal end 26 of the optic fiber core 22.

A cladding 28 with typical diameter 100-500 μm and refractive index RI_{clad} smaller than refractive index of core RI_{core} is provided around the fiber core 22. A polymer coating 30, typically made from material having smaller refractive index RI_{coat} than refractive index of cladding RI_{clad}, is then provided around the cladding 28.

An endcap 32 is attached to the distal end 26 of the optic fiber 22 with cladding 28. Since high heat is used to attach the endcap 32, a portion 34 of the outer coating 30 is typically stripped away thus leaving a stripped portion 34 of the cladding 28.

Still referring to FIG. 1, the optic fiber with core 22 and with its cladding 28 and coating 30 is positioned within a support tube 36. Typically the diameter of tube 36 is some hundreds of microns and weight of the tube in range of tens of milligrams. The support tube 36 extends through a mount 38 associated with the fiber optic core 22, cladding 28, and polymer coating 30.

In order to prevent contact between the cladding 28 of the optic fiber assembly 20 and its support tube 36, one or more drops 40 of a curable material, such as adhesive with refractive index RI_{glue} smaller than refractive index of cladding RI_{clad}, are placed on the stripped portion 34 of the optic fiber assembly 20. These drops 40 are allowed to cure thus forming a compressible, resilient, and solid material. Two or even more spaced drops of the curable material 40 can be placed or the stripped portion 34 of the fiber optic assembly 20.

The optical fiber assembly 20 is first positioned relative to a support tube 36 so that the stripped portion 34 protrudes outwardly from the distal end of the support tube 36.

With reference now to FIG. 2, after the curable material 40 has cured, most of the stripped portion 34 of the optical cable assembly 20 is retracted back into the support tube 36. In doing so, the drops 40 of curable material compress in between the cladding 28 for the assembly 20 and the support tube 36 thus isolating the cladding 28 from the support tube 36 and effectively preventing contact of the cladding 28 with the support tube 36 and leakage of parasitic radiation from cladding owing to total internal reflection on boundary between adhesive and cladding. Typically the thickness of curable material layer 40 is in range of tens of microns, and the placing of drop of material 40 as well as retracting the assembly 20 back into supporting tube 36 is accomplished under microscope.

After retraction of the stripped portion 34 of the fiber optic assembly 20 into the support tube 36 to the position shown in FIG. 2, a further drop 42 of adhesive material is preferably applied to the distal end of the support tube 36 and the cladding 28. The refractive index RI₄₂ of this drop adhesive 42 is less than RI_{clad} providing the optical insulation of cladding optical modes. This additional drop 42 not only ensures that the cable assembly 20 will not contact its support tube 36, but also serves to support the cable assembly 20 against wobbling which might otherwise occur during high frequency movement in many kHz range of the endcap 32 of the type typically used to focus the plurality of laser beams on the target in military applications. A drop 43 of adhesive material is additionally applied to the proximal end 37 of support tube 36 to ensure the further stopping the fiber optic assembly 20 from wobbling inside of support tube 36. The refractive index RI₄₃ of drop 43 is typically less than RI_{coat} of polymer coating 30.

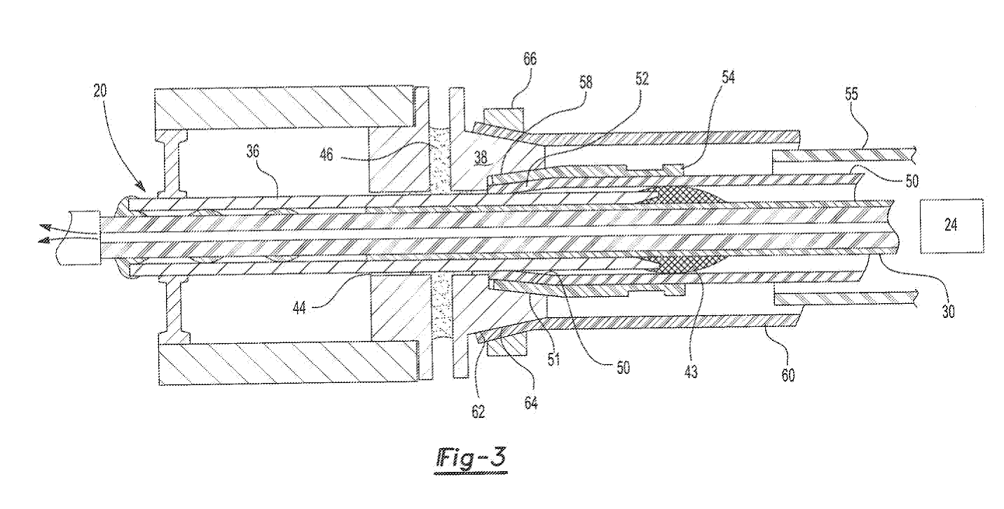

With reference now to FIG. 3, the mount 38 for the fiber optic assembly 20 includes a through passage 44 in which the support tube 36 extends and is secured in place by an adhesive 46 or screw. This passage 44, furthermore, includes an outwardly flared cavity 51 at its proximal end.

In order to protect the fiber optic extending between the mount 38 and the laser radiation source 24, a first protective sheath 50 has its distal end 52 positioned within the cavity 51 and thus around the support tube 36 for the cable assembly 20. This protective sheath 50 has the refractive index RI₅₀ smaller than the refractive index of polymer coating 30 providing the additional protection from occasional optical leakages from polymer coating 30 owing to total internal reflection between polymer coating 30 and sheath 50. Preferably the Teflon tube can be used due to that refractive index of Teflon ˜1.31 is among the smallest refractive indices for polymers. As best shown in FIGS. 3 and 4, a shimming lock 54 includes at least two, and preferably four or more, axially extending slots 56 which permit the shimming lock 54 to deflect radially inwardly. Consequently, upon insertion of the shimming lock 54 to the position shown in FIG. 3, the outwardly flared cavity 51 co-acts with the slotted end 56 of the shimming lock 54 thus causing fingers 58 on the shimming lock 54 caused by the slots 56 to deflect radially inwardly. In doing so, the shimming lock fingers 58 sandwich the free distal end 52 of the sheath 50 in between the shimming lock 54 and the support tube 36 for the optic fiber assembly 20. Consequently, the sheath 50 is firmly, but removably, attached to the mount 38. If required, the sheath 50 could be easily removed by simply removing the shimming lock 54.

Typically the shimming lock has diameter around 1 mm and weight 30-50 milligram, providing non-significant weight load to fiber assembly.

With reference now particularly to FIG. 3, an outer sheath 60 is also provided around the inner sheath 50 for additional protection of the optic fiber assembly 20. This outer sheath 60 is pressed over an outwardly flared portion 62 of the mount 38. In doing so, a distal end 64 of the outer sheath 60 is flared outwardly. In order to lock the distal end 64 of the outer sheath 60 to the mount 38, a compression ring 66 having an inner surface, which matches the outer surface 62 of the mount, is compressed against the mount 38 thus sandwiching the distal end 64 of the outer sheath 60 in between the compression ring 66 and the mount 38. In doing so, the outer sheath 60 is firmly, but removably, secured to the mount 38. Typically the compression ring 66 has diameter 3-5 mm and weight 50-100 milligrams, providing non-significant gravity load on fiber assembly.

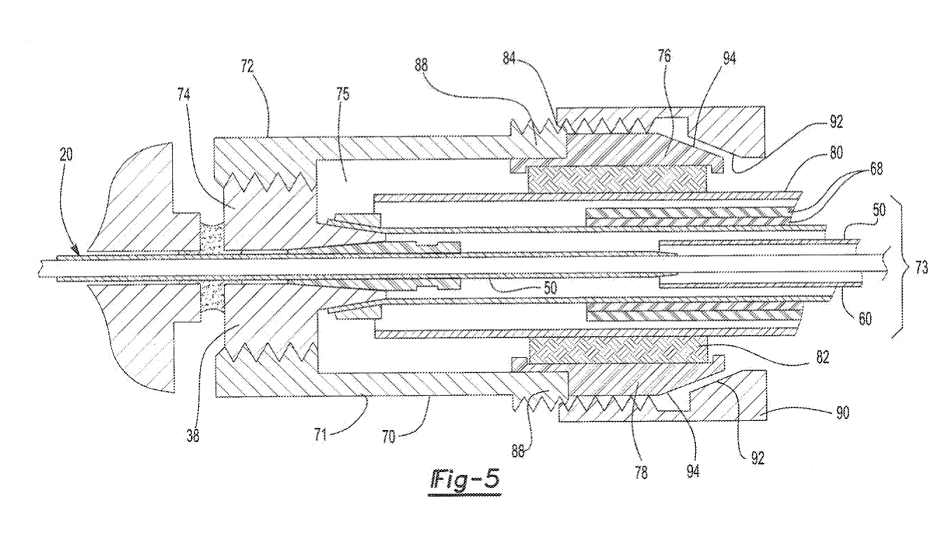

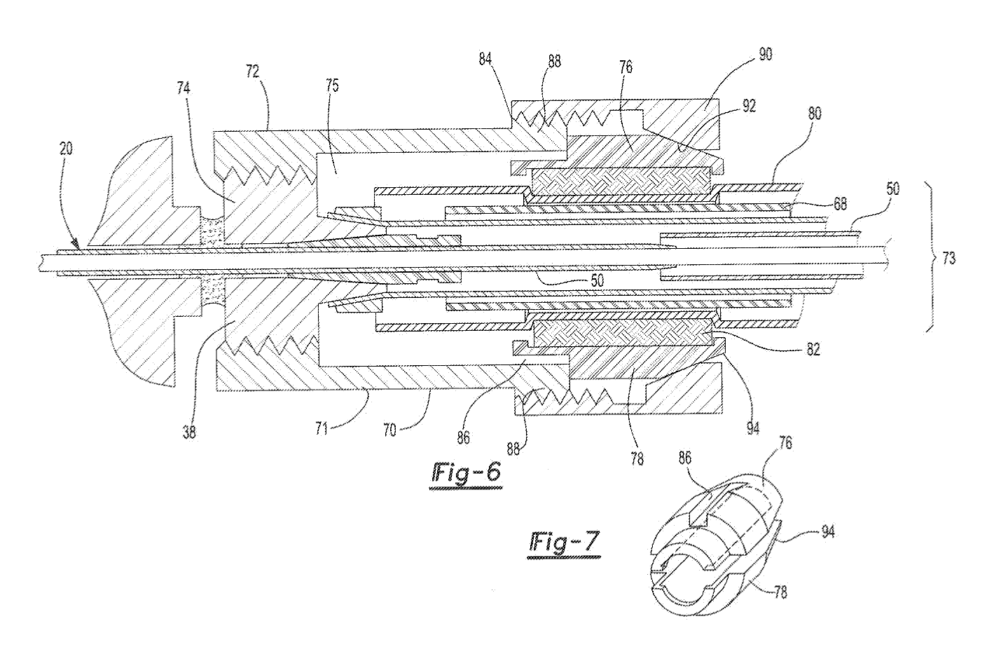

With reference now to FIGS. 5 and 6, the outer plastic sheath 80 is added above of plastic sheath 60 for increase of overall robustness and further protection of fiber optic assembly. Optionally, an aramid (Kevlar) layer 68 is contained in between the sheath 60 and outer sheath 80 as it made for instance in commonly used furcation tubing in fiber optic industry. The aramid (Kevlar) layer 68 provides a further protection of fiber assembly 20.

Still with reference to FIGS. 5 and 6, an adapter 70 which may be used to provide structural support of the optical fiber assembly 20 at any position along its length is shown. This adapter 70 firmly connects the outer plastic sheath 80 with mount 38 by gentle clamping of outer sheath 80 without stresses to inner sheaths 60 and 50, hence without stress to fiber 20. The adapter 70 includes a generally tubular and cylindrical body 71 thus forming a through passageway 75 through which the fiber assembly 73 extends (including fiber core 20, cladding 28, polymer coating 30, Teflon tube 50, furcation tubing 60-68-80). One end 72 of the adapter body 71 is attached to a structure 74, such as the mount 38, in any conventional fashion, such as by a threaded connection as shown in FIGS. 5 and 6. Other mechanisms for securing the adapter 70 to the structure 74 may alternatively be used.

Still referring to FIGS. 5-7, a pair of inserts 76 and 78 is disposed around an outer sheath 80 for the fiber assembly 73. These inserts 76 and 78, furthermore, are movable radially relative to each other.

Optionally, a compressible gasket 82 is positioned around the outer sheath 80 in alignment with the inserts 76 and 78. The inserts 76 and 78 are, furthermore, at least partially contained within an end 84 of the adapter body 71. In addition, the inserts 76 and 78 each includes a longitudinally extending slot(s) 86 which cooperate(s) with tabs 88 on the adapter body 71 to prevent rotation of the inserts 76 and 78 relative to the adapter 70.

As best shown in FIGS. 5 and 6, a nut 90 threadably engages the adapter body 71. This nut 90 includes an annular conical surface 92 which cooperates with a conical surface 94 on the inserts 76 and 78. Consequently, upon tightening of the nut 90, the nut 90 moves the inserts 76 and 78 radially inwardly from the position shown in FIG. 5 to the position as shown in FIG. 6. This in turn compresses the gasket 82 against the outer sheath 80 and firmly secures the outer sheath 80 to the adapter 70. Typically the weight of adapter is of the order of 2-3 grams, which is small fraction ˜10% of weight of mount 38.

Similar adapter 70-R in reverse orientation (“second adapter”) can be used for protection of outer sheath 80 on a remaining distance from adapter 70 to radiation source 24. The end 72-R of second adapter is connected to distal end of metal conduit above (outwardly) the outer plastic sheath 80. When the nut 90-R of second adapter 70-R is not tightened the proximal end of metal conduit can be easily glided and attached to radiation source 24. After tightening the nut 90-R in second adapter 70-R the distal end of metal conduit is firmly attached to plastic sheath 80 in position, where fiber assembly 20, inner Teflon tube 50 and inner sheath 60 are in stress-free condition from endcap 32 to laser 24.

From the foregoing, it can be seen that the present invention provides several improvements over the previously known cable assemblies of the type used in military applications. Having described my invention, however, many modifications thereto will become apparent to those skilled in the art to which it pertains without deviation from the spirit of the invention as defined by the scope of the appended claims.

I claim:

1. A method for mounting an optic fiber to a flexible tube comprising the steps of:
inserting the optic fiber through a tube so that a portion of said fiber protrudes outwardly from a distal end of said tube,
applying a curable material to said fiber portion which, upon curing, forms a flexible solid material with refractive index less than refractive index of cladding of said fiber optic,
retracting said fiber portion into said tube so that said flexible solid material isolates said fiber portion from said tube and provides simultaneously the optical isolation of fiber optic for radiation propagating in cladding.

2. The invention as defined in claim 1 wherein said curable material comprises an adhesive.

3. The invention as defined in claim 1 wherein said applying step comprises the steps of applying said curable material at a plurality of spaced locations along said fiber portion.

4. The invention as defined in claim 1 and comprising the step of applying said curable material to the distal end of said tube and to the proximal end of said tube after retracting said fiber portion into said tube.

5. The invention as defined in claim 1, wherein the distal end of said flexible tube capable to re-positioning in frequency range 1 kHz or more, preferably 5 kHz or more.

6. The invention as defined in claim 5, wherein the radiation power emitted from distal end of said fiber optic is 0.5 kW or more, preferably 1 kW or more or even preferably 1.5 kW or more.

7. The invention as defined in claim 5, wherein the beam quality of said radiation remains non-deteriorated during said re-positioning.

8. An optical fiber assembly comprising:
an optical fiber mounted through a tube,
a mount having a through passageway, said tube being positioned through said passageway and secured to said mount, said passageway having an enlarged diameter cavity at a proximal end of said passageway, and
a protective sheath disposed around said optical fiber, said sheath having one end adhesively secured to said mount within said cavity.

9. An optical fiber assembly comprising:
an optical fiber mounted through a tube,
a mount having a through passageway, said tube being positioned through said passageway and secured to said mount, said passageway having an outwardly flared cavity at a proximal end of said passageway,
a protective sheath disposed around said optical fiber, said sheath having one end positioned within said cavity, and
a flexible clamp disposed around said sheath within said cavity, said clamp dimensioned to compress against said sheath upon insertion into said cavity.

10. The optical fiber assembly as defined in claim 9 wherein said sheath comprises polytetrafluoroethylene or other polymer having the refractive index less than refractive index of polymer coating of said fiber optic.

11. The optical fiber assembly as defined in claim 9 and comprising a second protective sheath disposed around said first mentioned sheath, said second sheath having a distal end disposed over a conical outer surface on said mount, and a compression ring which sandwiches said second sheath between said compression ring and said conical outer surface on said mount.

12. The optical fiber assembly as defined in claim 11 and comprising a third protective sheath disposed around said second sheath, said third sheath having a distal end disposed over a second conical outer surface on said mount, and a second compression ring which sandwiches said third sheath between said second compression ring and said second conical outer surface on said mount.

13. The optical fiber assembly as defined in claim 12 and comprising an aramid layer disposed between said second and third sheaths.

14. An optical fiber assembly comprising:
an optical fiber,
a protective sheath disposed around said optical fiber,
a structure through which said optical fiber extends,
a tubular and generally cylindrical adapter having one end secured to said structure so that said optical fiber extends axially through said adapter,
an insert assembly having two radially movable inserts, each insert having a conical surface, said inserts disposed around said tube and at least partially inside said adapter,
a nut thread ably attached to said adapter, said nut having an annular surface which cooperates with said insert conical surfaces to move said inserts radially inwardly toward said tube upon tightening of said nut.

15. The optical fiber assembly as defined in claim 14 and comprising a resilient and compressible gasket sandwiched between said inserts and said protective sheath.

16. The optical fiber assembly as defined in claim 14 wherein said structure comprises a mount.

17. The optical fiber assembly as defined in claim 14 wherein said structure comprises protective tubing.

18. The optical fiber assembly as defined in claim 14 wherein at least one insert includes an axial slot which slidably receives a tab on said adapter to lock said insert assembly against rotation relative to said adapter.

19. The optical fiber assembly as defined in claim 17 wherein said protective tubing is metal or plastic conduit slidably movable from said adapter to laser source.
